(19) United States
(12) Patent Application Publication
(10) Pub. No.: US 2024/0362055 A1
(43) Pub. Date: Oct. 31, 2024

(54) DATA MATERIALIZATION FOR STORAGE OPTIMIZATION IN A CLOUD COMPUTING ENVIRONMENT

(71) Applicant: Taiwan Semiconductor Manufacturing Company, Ltd., Hsinchu (TW)

(72) Inventors: Grzegorz Piotr SZCZEPANIK, Krakow (PL); Kushal S. PATEL, Pune (IN); Sarvesh S. PATEL, Pune (IN); Lukasz Jakub PALUS, Krakow (PL)

(21) Appl. No.: 18/309,028

(22) Filed: Apr. 28, 2023

(51) Int. Cl. G06F 9/455

(52) U.S. Cl. CPC G06F 9/45558; G06F 2009/4557; G06F 2009/45579; G06F 2009/45583

(57) ABSTRACT

In some implementations, a data materialization platform may perform a data migration process between a core cloud environment and an edge cloud environment. The data materialization platform may identify, in association with the data migration process, attribute values stored in a data repository of the core cloud environment, wherein the attribute values are to be used as inputs for a machine learning model that is to be executed by the edge cloud environment. The data materialization platform may analyze the attribute values to identify ranges, associated with a subset of the attribute values, for which outputs of the machine learning model are estimated to be approximately a same output. The data materialization platform may deduplicating, by the data materialization platform, the subset of the attribute values from the data repository of the core cloud environment to generate deduplicated attribute values that are associated with median range values.

### BACKGROUND

An edge cloud environment may include an interchangeable cloud ecosystem encompassing storage and compute assets located at an edge of a cloud-implemented platform. The edge cloud environment may be connected with other cloud environments of the cloud-implemented platform by a scalable application-aware network that can sense and adapt to changing conditions in a secure and real-time manner. An edge cloud environment may provide multi-access edge computing (MEC) to enable cloud computing capabilities within an information technology (IT) service environment at the edge of the cloud-implemented platform. MEC enables the edge cloud environment to provide decentralized processing power to client devices associated with the cloud-implemented platform. This enables applications to be executed (and related processing tasks to be performed) closer to the client device which, in turn, reduces network latency and congestion.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A and 1B are diagrams of an example implementation of a cloud computing platform configured to perform data materialization, as described herein.

FIG. 2 is a diagram of an example implementation described herein.

FIG. 3 is a diagram of an example implementation described herein.

FIG. 4 is a diagram of an example environment in which systems and/or methods described herein may be implemented.

FIG. 5 is a diagram of example components of a device associated with data materialization for repository optimization in a cloud computing environment.

FIG. 6 is a flowchart of an example process associated with data materialization for repository optimization in a cloud computing environment.

FIG. 7 is a flowchart of an example process associated with data materialization for repository optimization in a cloud computing environment.

FIG. 8 is a flowchart of an example process associated with data materialization for repository optimization in a cloud computing environment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Traditionally, computing power of servers is used to perform computational tasks such as data minimization, data deduplication, and/or to create advanced distributed systems, among other examples. Within a cloud-implemented platform, such computational tasks may be performed by cloud infrastructure or cloud computing systems so that results of the computational tasks can be transferred to other devices with less or almost no computing power. In some cases, a cloud-implemented platform may include multiple distributed cloud environments, such as an edge cloud environment located at the edge of a network and a core cloud environment located in a data center.

Servers may offer a centralized approach to managing data. Information is collected at the outer edges of a network from client devices such as internet of things (IoT) devices, mobile devices, and/or another type of client devices. The information is then transferred to the servers at a core of the network for storage and processing so that instructions and/or other responses can be sent to the client devices at the edge of the network. However, this centralized approach to managing data introduces significant latency delays due to the length round trip between the client devices and the servers.

A cloud-implemented platform may enable edge computing to be performed in an edge cloud environment. Edge computing upends traditional architecture by shifting storage and processing functions away from the core of the network and out to the edge of the network closer to the client devices. Edge computing (e.g., performing computational tasks at the edge of the network) can greatly improve network performance and reduce latency for the client devices. Moreover, edge computing may reduce the consumption of networking resources in the network in that edge computing and may reduce the amount of overall data traffic between the edge and the core of the network.

Edge computing may become more prevalent in advanced networks such as fifth-generation (5G) wireless networks. In an advanced network, an increased focus may be placed on remote data storage and processing in an edge cloud environment to enable network infrastructure management and to reduce the consumption of network resources in support of serving many millions of subscribers and client devices. Moreover, remote data storage and processing in the edge cloud environment may enable the advanced network to perform advanced processing operations for the client devices, such as machine learning, artificial intelligence, and/or neural networks, among other examples. Data may be transferred or migrated from a core cloud environment of the cloud-implemented platform to the edge cloud environment to facilitate training of machine learning models and the use of the machine learning models to generate outputs for client devices.

While edge computing may reduce latency and enable advanced processing at the edge of the network, resources of the edge cloud environment (e.g., computing resources, memory resources, storage resources) may be limited and costly. Thus, maintaining large data sets for machine learning at the edge cloud environment may be impractical or infeasible. This can reduce the ability to train a machine learning model, as data sets with millions and millions of records (also referred to herein as feature-set values) are often used to train and refine a machine learning model. As a result, the edge cloud environment may be unable to support advanced processing for the client devices, which can lead to reduced user experience and reduced services for the client devices. Moreover, the edge cloud environment may be unable to train a machine learning model on a sufficiently large data set, which can result in the machine learning model providing inaccurate outputs. The edge cloud environment may need to rerun the machine learning model multiple times in order to generate an accurate output, which results in increased consumption of processing resources and memory resources of the edge cloud environment.

Some implementations described herein provide techniques and apparatuses for data materialization in a cloud computing environment. In some implementations, a data materialization platform includes a core cloud environment and an edge cloud environment. The data materialization platform may transfer or migrate data between the core cloud environment and the edge cloud environment to support advanced processing operations such as machine learning. In connection with migration of a data set that includes many records (e.g., thousands of records, millions of records), the core cloud environment may deduplicate the data set to reduce the amount of storage resources that are consumed by the core cloud environment in storing the data set.

As described herein, the core cloud environment may perform a boundary derivation of attributes included in the data set. Here, records that have attribute values (which may include data set values and/or vectors, among other examples) that are within a same range are assigned a median attribute value associated with the range. The records can then be deduplicated (e.g., duplicate records are removed from the data set, and only a single record is retained). Ranges may be identified for which outputs of a machine learning model, that is to be used by the edge cloud environment to perform advanced processing operations for a client device, are estimated to be approximately a same output. In other words, two records that have the attribute values within a same range are estimated to result in approximately a same output from the machine learning model (e.g., within approximately 0.1% tolerance, within approximately 1% tolerance, and/or within another tolerance). Since these two records result in approximately the same output, the two records can be generalized and deduplicated since maintaining them both in the data set does not provide increased data differentiation for training the machine learning model.

In this way, records that have attribute values that are within a same range may be deduplicated such that storage resources and/or memory resources of the edge cloud environment can be conserved. Moreover, records that have attribute values that are within a same range may be deduplicated such that the storage resources and/or the memory resources of the edge cloud environment can be used to store other records that have attribute values that provide increased data differentiation for training the machine learning model. This enables the edge cloud environment to more effectively train the machine learning model to provide more accurate outputs. This reduces the likelihood that the edge cloud environment will rerun the machine learning model in order to generate an accurate output, which may conserve processing resources and memory resources of the edge cloud environment.

In this way, the data materialization techniques described herein enable boundary derivation of participating attributes (and relations) that are made in a machine learning model. In this way, the data materialization techniques described herein enable validation of boundary derivations when a data fetch is initiated by the edge cloud environment. In this way, the data materialization techniques described herein enable data to be pushed to the edge cloud environment with effective deduplication capability. In this way, the data materialization techniques described herein enable data tuning performed during data migration from the core cloud environment to the edge cloud environment for last mile delivery computation in a network. In this way, the data materialization techniques described herein enable commonality infrastructures, such as 5G service orchestration layers, to reduce the storage burden of training data for machine learning at the edge cloud environment.

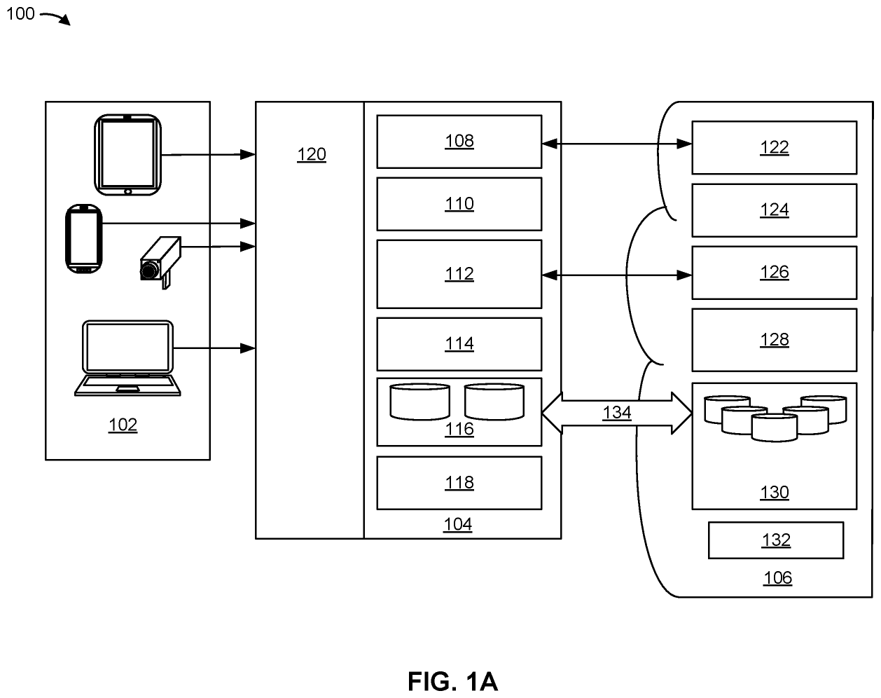

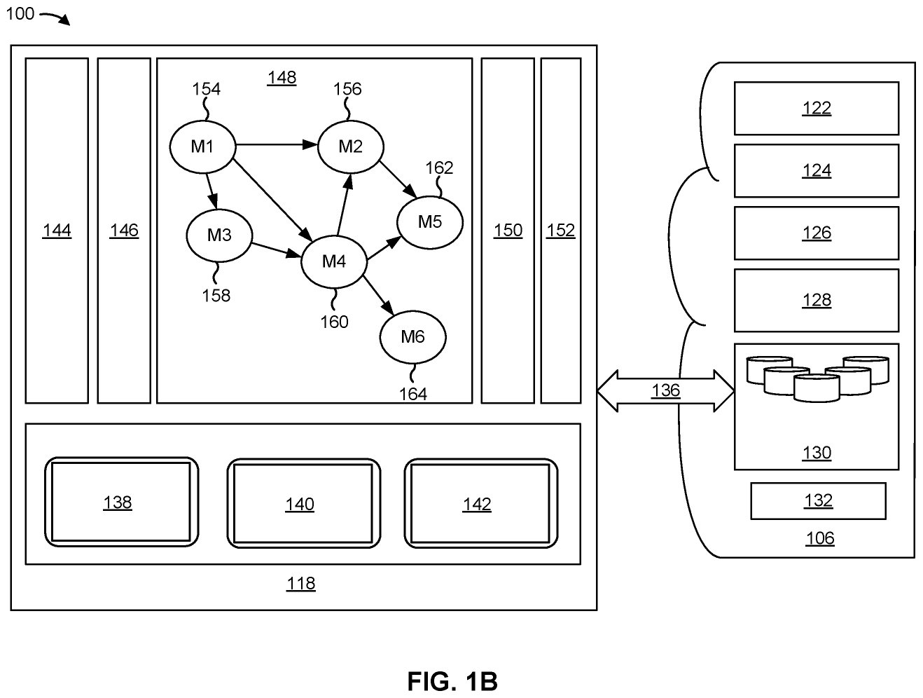

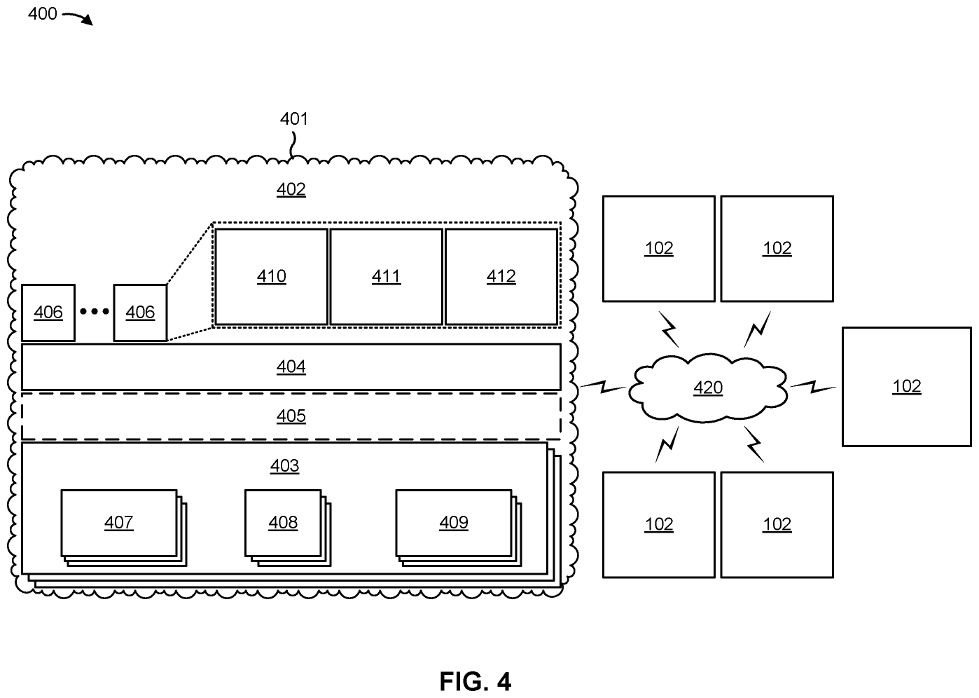

FIGS. 1A and 1B are diagrams of an example implementation 100 of a cloud computing platform configured to perform data materialization, as described herein. One or more client devices 102 may communicate with the cloud computing platform to obtain services, such as computing services, storage services, communication services, and/or another type of services. Examples of client devices 102 are described elsewhere herein, such as in connection with FIG. 4. The cloud computing platform may be implemented by a platform, such as a data materialization platform 401 described in connection with FIG. 4.

As shown in FIG. 1A, the cloud computing platform may include an edge cloud environment 104 and a core cloud environment 106. The edge cloud environment 104 may be located at an edge of a network, whereas the core cloud environment 106 may be located in a core of the network. Thus, the cloud computing platform may be a distributed platform in which cloud computing systems are physically and geographically distinct, and are operated as a single platform.

The edge cloud environment 104 may be configured to communicate with the client devices 102 and to perform processing and/or storage operations for the client devices 102. For example, the edge cloud environment 104 may perform video rendering for the client devices 102. As another example, the edge cloud environment 104 may perform content delivery for the client devices 102, such as delivery of electronic files (e.g., video files, application files), video and/or audio streaming, and/or another type of content delivery. As another example, the edge cloud environment 104 may perform advanced processing operations for the client devices 102, such as machine learning operations, artificial intelligence operations, and/or neural network processing, among other examples.

The edge cloud environment 104 may include an edge application component 108, an execution logic component 110, a process and data coordinator component 112, a data pull engine 114, a data repository 116, an edge cloud infrastructure 118, and/or a data interaction logic and user interface (referred to as interface 120), among other examples.

The edge application component 108 may provide one or more host applications that are interacted with by the client devices 102. For example, edge application component 108 may provide a communication application (e.g., a video conferencing application, a telecommunications application), a video game application, an extended reality application (e.g., a virtual reality application, an augmented reality application), a data processing application (e.g., an application that processes inputs using a machine learning model), and/or another type of application.

The execution logic component 110 may provide a database of operations that may be executed (and the logic for executing those operations) by the edge cloud environment 104. The process and data coordinator component 112 may be configured to coordinate the processes between the edge cloud environment 104 and the core cloud environment 106 and/or may be configured to coordinate the transfer of data between the edge cloud environment 104 and the core cloud environment 106, among other examples. The data pull engine 114 may interact with the process and data coordinator component 112 to pull or request data from the core cloud environment 106.

The data repository 116 includes one or more databases, one or more file systems, and/or one or more of another type of data structures that are configured to store data and information in the edge cloud environment 104. The data repository 116 may be a data/knowledge repository and/or a database that may be written to and/or read by one or a combination of the client devices 102, the edge cloud environment 104, and/or the core cloud environment 106. As shown in FIG. 1A, the data repository 116 may reside in the edge cloud environment 104. Alternatively, the data repository 116 may reside elsewhere within the cloud computing environment, provided that the data repository 116 is associated with the edge cloud environment 104 and accessible by the client devices 102, the edge cloud environment 104, and/or the core cloud environment 106. The data repository 116 may be implemented with any type of storage device capable of storing data and configuration files that may be accessed and utilized by the client devices 102, the edge cloud environment 104, and/or the core cloud environment 106, such as a database server, a hard disk drive, and/or a flash memory, among other examples.

The edge cloud infrastructure 118 may implement and/or execute one or more of the edge application component 108, the execution logic component 110, the process and data coordinator component 112, the data pull engine 114, the data repository 116, and/or the interface 120. Details of the edge cloud infrastructure 118 are described elsewhere herein, such as in connection with FIGS. 1B, 4, and 5.

The interface 120 includes a wireless communication interface, a wired communication interface, a graphical user interface (GUI), a web user interface (WUI), and/or another type of interface that enables communication between the client devices 102 and the edge cloud environment 104. A client device 102 interact with the edge cloud environment 104 and/or the core cloud environment 106 in various ways through the interface 120, such as sending program instructions, receiving program instructions, sending and/or receiving messages, updating data, sending data, inputting data, editing data, collecting data, and/or receiving data. In some implementations, the interface 120 may display documents, web browser windows, user options, application interfaces, and/or instructions for operation, among other examples. The interface 120 may present data (e.g., graphic, text, sound, video) and/or may control sequences the user employs to control operations associated with the data. In some implementations, the interface 120 may be a mobile application interface providing an interface between a user of a client device 102 and the edge cloud environment 104 and/or the core cloud environment 106. In some implementations, the interface 120 may enable a user of a client device 102 to send data, input data, edit data (e.g., annotate the data), collect data, and/or receive data from the edge cloud environment 104 and/or the core cloud environment 106, among other examples.

The core cloud environment 106 may be configured to communicate with the edge cloud environment 104 and to perform processing and/or storage operations for the edge cloud environment 104. For example, the core cloud environment 106 may store large data sets (e.g., data sets that includes thousands or millions of records). As another example, the core cloud environment 106 may perform data deduplication for the edge cloud environment 104. Here, the core cloud environment 106 may deduplicate records of a data set to remove duplicative records having the same or similar attribute values to reduce the size of the data set. As another example, the core cloud environment 106 may provide data sets to the edge cloud environment 104 to support advanced processing operations performed by the edge cloud environment 104, such as machine learning operations, artificial intelligence operations, and/or neural network processing.

The core cloud environment 106 may function as a repository of elements of the cloud computing platform. The core cloud environment 106 may provide a highly resilient, available, secure, and performant set of network services that are exposed in a cost-effective, on-demand, and elastic way as a network platform through a set of application programming interfaces (APIs) and/or user interfaces. In some implementations, the core cloud environment 106 may be cloud environment that is not directly accessed by user applications on the client devices 102 since the user applications access the host applications in the edge cloud environment 104.

The core cloud environment 106 may include an application layer 122, an application interface 124, a data coordinator component 126, a data management layer 128, a data repository 130, and/or a core cloud infrastructure 132, among other examples.

The application layer 122 may provide a set of protocols (e.g., application protocols) for application-to-application (or process-to-process) communications between host applications, between a host application and a client application, and/or between a host application and the core cloud environment 106, among other examples. Examples of protocols include hypertext transfer protocol (HTTP), file transfer protocol (FTP), and/or web real-time communication (WebRTC), among other examples.

The application interface 124 may provide an interface through which applications may communication. The application interface 124 may enable communication between a host application and a client application, and/or between a host application and the core cloud environment 106, among other examples.

The data coordinator component 126 may coordinate the transfer or migration of data between the data repository 116 and the data repository 130. The data management layer 128 may provide a set of protocols for data storage formats for the data repository 116 and/or the data repository 130, for storage optimization for the data repository 116 and/or the data repository 130, and/or for access management of the data repository 116 and/or the data repository 130, among other examples.

The data repository 130 includes one or more databases, one or more file systems, and/or one or more of another type of data structures that are configured to store data and information in the core cloud environment 106. The data repository 130 may be a data/knowledge repository and/or a database that may be written to and/or read by one or a combination of the client devices 102, the edge cloud environment 104, and/or the core cloud environment 106. As shown in FIG. 1A, the data repository 130 may reside in the core cloud environment 106. Alternatively, the data repository 130 may reside elsewhere within the cloud computing environment, provided that the data repository 130 is associated with the core cloud environment 106 and accessible by the client devices 102, the edge cloud environment 104, and/or the core cloud environment 106. The data repository 130 may be implemented with any type of storage device capable of storing data and configuration files that may be accessed and utilized by the client devices 102, the edge cloud environment 104, and/or the core cloud environment 106, such as a database server, a hard disk drive, and/or a flash memory, among other examples.

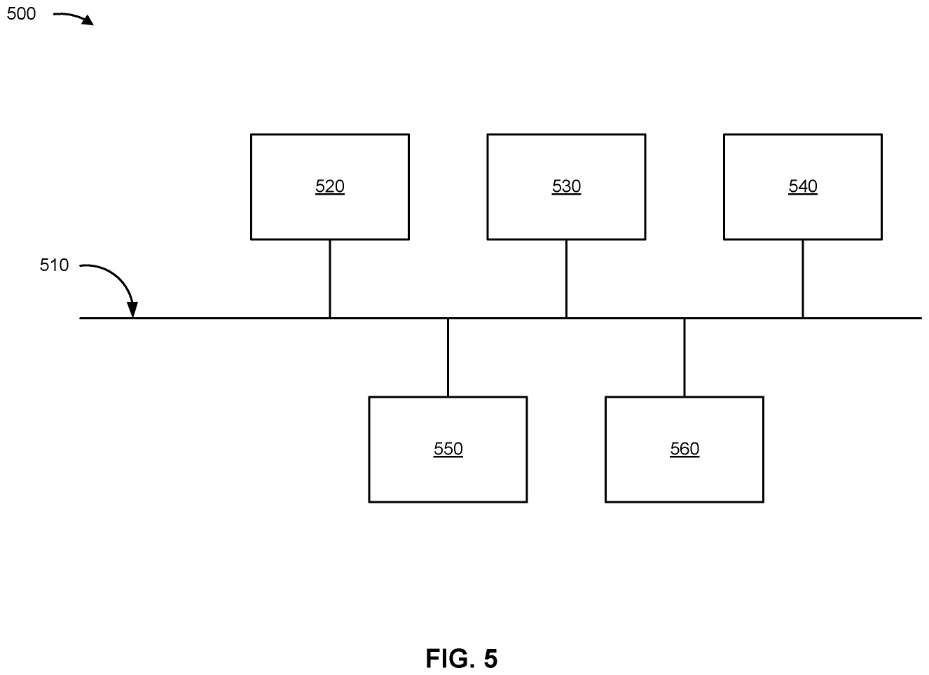

The core cloud infrastructure 132 may implement and/or execute one or more of the application layer 122, the application interface 124, the data coordinator component 126, the data management layer 128, and/or the data repository 130. Details of the core cloud infrastructure 132 are described elsewhere herein, such as in connection with FIGS. 4 and 5.

Data may be transferred and/or migrated between the data repository 116 and the data repository 130 over a data bridge 134. The data bridge 134 may enable connectivity between the edge cloud environment 104 and the core cloud environment 106 by extending transparent network access to cloud-deployed resources and normalizing network access between the edge cloud environment 104 and the core cloud environment 106. The data bridge 134 may include a direct (e.g., peer-to-peer) connection, a network, and/or another type of communication link.

FIG. 1B illustrates details of the edge cloud infrastructure 118 that is included in the edge cloud environment 104. Operations that are described as being performed by the edge cloud infrastructure 118 may also be performed by the edge cloud environment 104, and operations that are described as being performed by the edge cloud environment 104 may also be performed by the edge cloud infrastructure 118. The edge cloud infrastructure 118 may include one or more components illustrated in FIG. 1B and/or one or more other components not shown in FIG. 1B. Additionally and/or alternatively, the edge cloud infrastructure 118 may include one or more other components illustrated in FIGS. 4 and/or 5.

As shown in FIG. 1B, data may be transferred and/or migrated between the edge cloud infrastructure 118 and the data repository 130 over a data bridge 136. The data bridge 136 may enable connectivity between the edge cloud environment 104 and the core cloud environment 106 by extending transparent network access to cloud-deployed resources and normalizing network access between the edge cloud environment 104 and the core cloud environment 106. The data bridge 136 may include a direct (e.g., peer-to-peer) connection, a network, and/or another type of communication link. In some implementations, the data bridge 134 and the data bridge 136 are the same data bridge. In some implementations, the data bridge 134 and the data bridge 136 are different data bridges.

As further shown in FIG. 1B, the edge cloud infrastructure 118 may include a hypervisor component 138, a networking component 140, a storage component 142, and/or another component.

The hypervisor component 138 may include a virtualization application (e.g., executing on hardware) capable of virtualizing computing hardware of the edge cloud infrastructure 118 to start, stop, and/or manage one or more virtual computing systems of the edge cloud infrastructure 118. For example, the hypervisor component 138 may include a hypervisor (e.g., a bare-metal or Type 1 hypervisor, a hosted or Type 2 hypervisor, or another type of hypervisor) or a virtual machine monitor, such as when the virtual computing systems are virtual machines. Additionally, or alternatively, the hypervisor component 138 may include a container manager, such as when the virtual computing systems are containers. In some implementations, the hypervisor component 138 executes within and/or in coordination with a host operating system executed on the edge cloud infrastructure 118.

The networking component 140 may include a wired networking device, a wireless network device, a networking interface, and/or another type of networking component. The storage component 142 may a memory device, a storage device (e.g., a hard disk drive (HDD) or solid state drive (SSD)), and/or another type of storage component.

As further shown in FIG. 1B, the edge cloud infrastructure 118 may include an interface functions component 144, a model management component 146, a model space 148, a core cloud connector component 150, and/or an API functions component 152, among other examples. The interface functions component 144 may implement and/or may be implemented by the interface 120.

The edge cloud infrastructure 118 may store one or more machine learning models 154-164 (corresponding to M1-M6, respectively) in the model space 148. Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

The model management component 146 may manage the machine learning models 154-164 in model space 148. The model management component 146 may allocate memory and processing resources to the model space 148 for use in executing the machine learning models 154-164. The machine learning models 154-164 in the model space 148 can communicate with each other and perform data handshaking with message queue-based intercommunication methods.

Low-level API functions provided by the API functions component 152 may enable communication with the application interface 124. The API functions component 152 may provide access to receive and establish queries for storage, processing, and/or memory configurations. These configurations are connected to the data coordinator component 126 in the core cloud environment 106 by the core cloud connector component 150.

The edge cloud infrastructure 118 may use a machine learning model, of the machine learning models 154-164 to receive an input value, a set of values for which the outcome is requested, and a training dataset that is used for training the machine learning model. The edge cloud infrastructure 118 may train the machine learning model to perform various operations, such as reading data from a data repository (e.g., the data repository 116, the data repository 130), to identify duplicate records in the data repository, to deduplicate the duplicate records, and/or to perform other another operation. To perform an operation, the machine learning model may generate a plurality of workload reads on an underlying repository (e.g., the data repository 116, the data repository 130) to obtain data to build a context and a ground truth for the machine learning model. A ground truth, as described herein, is information that is known to be real or true (e.g., the accuracy and truthfulness of the data has been verified), provided by direct observation and measurement (e.g., empirical evidence) as opposed to information provided by inference. The ground truth may be associated with a boundary derivation, and outcomes of processing by the machine learning model may be dependent on values that are boundary derivatives of the ground truth.

In some implementations, training dataset may include thousands and/or millions of records of a particular type, such as image files, tabulated data files, data tables, and/or another type of records. A record may include a tuple of attribute values that each have a different attribute value type. For example, a record may correspond to a semiconductor wafer. The record may include attribute values such as wafer diameter of the semiconductor wafer, die count (e.g., a quantity of dies) on the semiconductor wafer, and/or another attribute value. A training dataset of semiconductor wafer records may be transferred or migrated from the data repository 130 to the data repository 116 in the edge cloud environment 104 (e.g., over the data bridge 134 or 136). The edge cloud infrastructure 118 may train a machine learning model on the training dataset of thousands or millions (or more) records of semiconductor wafers to determine relationships between attribute values, to categorize records based on attribute values, and/or to perform other machine learning model training operations. In this way, the edge cloud infrastructure 118 may use the machine learning model to estimate or predict outcomes for semiconductor wafers (e.g., processing yield estimates, processing time estimates, estimates of device measurements on the semiconductor wafers) based on proposed semiconductor parameter changes as inputs to the machine learning model, in one example. The edge cloud infrastructure 118 may use the machine learning model to generate other semiconductor-related outputs and inferences.

As indicated above, storage resources in the data repository 116 in the edge cloud environment 104 and/or in the storage component 142 of the edge cloud infrastructure 118 may be limited. Thus, while training datasets that have thousands and/or millions of records may be used to train machine learning models 154-164 in the model space 148, duplicative records that do not meaningfully improve the training of the machine learning models 154-164 may result in wasted storage resources and/or memory resources of the data repository 116 and/or of the storage component 142.

To storage resources and/or memory resources of the data repository 116 and/or of the storage component 142 while still enabling sufficiently large training datasets to be stored in the edge cloud environment 104, the core cloud environment 106 and/or the core cloud infrastructure 132 may deduplicate records in a training dataset that are estimated to not meaningfully improve the training of the machine learning models 154-164. The core cloud infrastructure 132 may use a machine learning model and one or more cloud interface objects to perform one or more data repository operations to provide effective data transmission and storage of training datasets using boundary derivation of the machine learning model. Boundary derivation may refer to the determination or identification of a range and upper and lower boundaries of the range. The range may be associated with an attribute value of an attribute value type (or data set value or vector) associated with a record. The core cloud infrastructure 132 may use the machine learning model to identify distinct ranges in which attribute values of a particular attribute value type are estimated to not meaningfully improve the training of the machine learning models 154-164. In other words, the core cloud infrastructure 132 may use the machine learning model to identify a range of attribute values of a particular attribute value type that, if used as input to a machine learning model of the machine learning models 154-164, is estimated to result in an approximately same output from the machine learning model.

As an example of the above, and for a semiconductor wafer diameter attribute value type, the core cloud infrastructure 132 may use the machine learning model to identify a plurality of distinct ranges (e.g., non-overlapping ranges) of semiconductor wafer diameter values. For example, the core cloud infrastructure 132 may use the machine learning model to identify a first range (e.g., a range that is bound by boundary values of approximately 100 millimeters and approximately 199 millimeters), a second range, (e.g., a range that is bound by boundary values of approximately 200 millimeters and approximately 299 millimeters), a third range, (e.g., a range that is bound by boundary values of approximately 300 millimeters and approximately 399 millimeters), and so on. The core cloud infrastructure 132 may identify these ranges because, using the machine learning model, the core cloud infrastructure 132 may determine that semiconductor wafer diameter values that are within the first range are estimated to result in approximately a same output from another machine learning model (e.g., are estimated to have little to no impact on the outputs from the other machine learning model) that is used to generate inferences and/or outputs associated with semiconductor wafers. The core cloud infrastructure 132 may identify the second range and third range based on similar determinations.

The core cloud infrastructure 132 may associate the ranges of a particular attribute value type with a median range value. A median range value refers to a value that is selected as a median value within a range associated with a particular attribute value type. For example, a semiconductor device defect rate attribute value type may have a range of approximately 0.5% to approximately 1%, and this range may be associated with a median range value of 0.75% based on the quantity of records that are analyzed and the associated attribute values.

Associating ranges of a particular attribute value type enables the core cloud infrastructure 132 to duplicate records in a training dataset. For example, the core cloud infrastructure 132 may analyze the attribute values in the records of a training dataset, may determine which range the attribute values of the records are within, and may modify or replace the attribute values to be the median range values that are associated with those ranges. From there, the core cloud infrastructure 132 may identify records that have the same attributes with the same median range values, and remove duplicative records from the training dataset that have the same attributes with the same median range values. The core cloud infrastructure 132 may retain a single record with the median range value to conserve storage resources and/or memory resources for storing the training dataset in the data repository 116. In some implementations, the core cloud infrastructure 132 may add metadata to the training dataset to indicate a quantity of records that were associated with each range to enable the machine learning models 154-164 to appropriately determine weights for particular training dataset records when training. The core cloud infrastructure 132 may transfer or migrate the training dataset from the data repository 130 to the data repository 116 (e.g., on the data bridge 134 and/or on the data bridge 136) after deduplicating the records of the training dataset.

In some implementations, the core cloud infrastructure 132, via boundary-based derivation of a machine learning model function, initiates data movement and/or moves data from core cloud to edge cloud. More specifically, the core cloud infrastructure 132, via boundary-based derivation of a machine learning model to obtain time and space benefits of highly priced edge location in the multi-cloud architecture, may initiate data movement and/or moves data from the core cloud environment 106 to the edge cloud environment 104.

In various embodiments, the core cloud infrastructure 132 runs or executes two processes, where one process runs at the cloud orchestration services plane alongside the data migration process between core cloud environment 106 and the edge cloud environment 104 while the second process is situated with a machine learning model that is used to determine the ranges. In some implementations, the machine learning model is provided with more input datasets and a training dataset connector function that points to the data repository 130 on the core cloud environment 106 and an associated mathematical model. The core cloud infrastructure 132, using the machine learning model, may locate one or more attribute values and a relationship of the one or more attribute values to identify a value propagation of the attribute values for which the result will be the same.

The core cloud infrastructure 132 may request and/or retrieve the ground truth and extract one or more boundary definitions for each value participating in the decision making for a machine learning model. In some implementations, in case of a multidimensional model having multiple attribute relations, the core cloud infrastructure 132 extracts the boundaries for individual relationships to enquire the ground-truth values. In some implementations, in case of mathematical model-based information, the core cloud infrastructure 132 performs the processing by sending various feature-set value ranges to the model to understand the range of the attribute for which the same results are received. In some implementations, when the existing ground truth is extracted, the instance in the mathematical model creates the rules for which the results are identical. These rules may include the model's input attribute value ranges along with internally generated values for a multi-pass model. The outcome of this process may be the rules with a set of attribute values based on the relationship along with the range of each attribute for the relationship.

As an example, in a loan approval scenario, the ground truth may indicate that if the age is between {45, 60}, and income is {100000, 200000}, then the loan is approved. The baseline valuation mining may indicate that the combination for {age, income}, which may directly impact the loan approval based on the predetermined rule where age and income are in a certain range, then the outcome will be identical. In this example, the core cloud infrastructure 132 determines that the income and the age are the range bound attributes and that these range bound attributes are not needed in their accurate presentation. If the exact values are not used for any predetermined task or function and/or if the ground truth is frequently obtained from the core cloud environment 106, the core cloud infrastructure 132 may migrate the training datasets to edge cloud environment 104 (e.g., from the data repository 130 to data repository 116 over the data bridge 134 and/or the data bridge 136) to receive the performance befits associated with the frequently accessed data. Frequently accessed data may refer to data that is accessed greater than or equal to a predetermined number, threshold, or range. The core cloud infrastructure 132 may access one or more baseline records for, but not limited to, model retraining, consistent model auditing, and/or for another use.

In some implementations, once the model rules are created for the range attributes including one or more relations, the core cloud infrastructure 132 may generate and/or output an indication to one or more peer processes running at/on a cloud service level. The one or more peer processes may be responsible for data migration in the data materialization platform. The core cloud infrastructure 132 may receive a request and may determine, based on the received request, the range orientation of the model outcomes. In some implementations, if dataset migration to the data repository 116 in the edge cloud environment 104 is triggered, the nature of the request is obtained, where the nature of the request is a series orientation. In some implementations, as training datasets are migrated to the edge cloud environment 104, the core cloud infrastructure 132 may alter the training datasets for improved deduplication. In some implementations, prior to transmission of the training datasets to the edge cloud environment 104, the core cloud infrastructure 132 copies the training datasets to a temporary space and value alteration is then executed.

In some implementations, for value adjustment, the core cloud infrastructure 132 obtains the rules from a peer model process. Based on the retrieved and/or received rules, the data in feature-set vectors (or records) of the training datasets are altered based on their current value tuples (e.g., the tuples of attribute values). In some implementations, while selecting base values for the attribute values, the core cloud infrastructure 132 selects the median range values so that they have overlapping alteration durations. Here, the core cloud infrastructure 132 provides the training datasets to edge cloud environment 104. The core cloud infrastructure 132 may update the training dataset values and vectors based on input rules. In some implementations, the core cloud infrastructure 132 generates and/or assigns a value to training dataset values and vectors based on the input rules. By updating the dataset values and vectors based on the input rules, the dataset values and vectors include a value and can be deduplicated at the edge cloud environment 104 (or at the core cloud environment 106) which conserves storage resources at the edge cloud environment 104.

In some implementations, the core cloud infrastructure 132 modifies the attributes so that the attributes outcome/value remains constant which enables capacity saving during storage without compromising results. In some implementations, if the core cloud infrastructure 132 identifies a change in one or more rules at the model process, then the new rules (e.g., the changed/updated rules) are supplied to a cloud migrator instance, and training datasets stored in the data repository 116 of the edge cloud environment 104 are updated to maintain the consistency. The provides increased model capacity, increases the capability for processing the training datasets at a closer proximity to the end user (e.g., to the client devices 102) to obtain real-time performance benefits, and/or conserves storage capacity at the edge cloud environment 104 to have a direct cost impact on the deployment environment, among other examples. In some implementations, the core cloud infrastructure 132 retrieves and/or receives at least the changed/updated rules. When the edge application component 108 issues a data pull operation from the edge cloud environment 104 to the core cloud environment 106, the information from the ground truth will be obtained to understand the boundaries of the dataset values and these ranges are the rules that can be used for feature-set alteration before sending the datasets.

As described above, FIGS. 1A and 1B are provided as an example. Other examples may differ from what is shown and described in connection with FIGS. 1A and 1B.

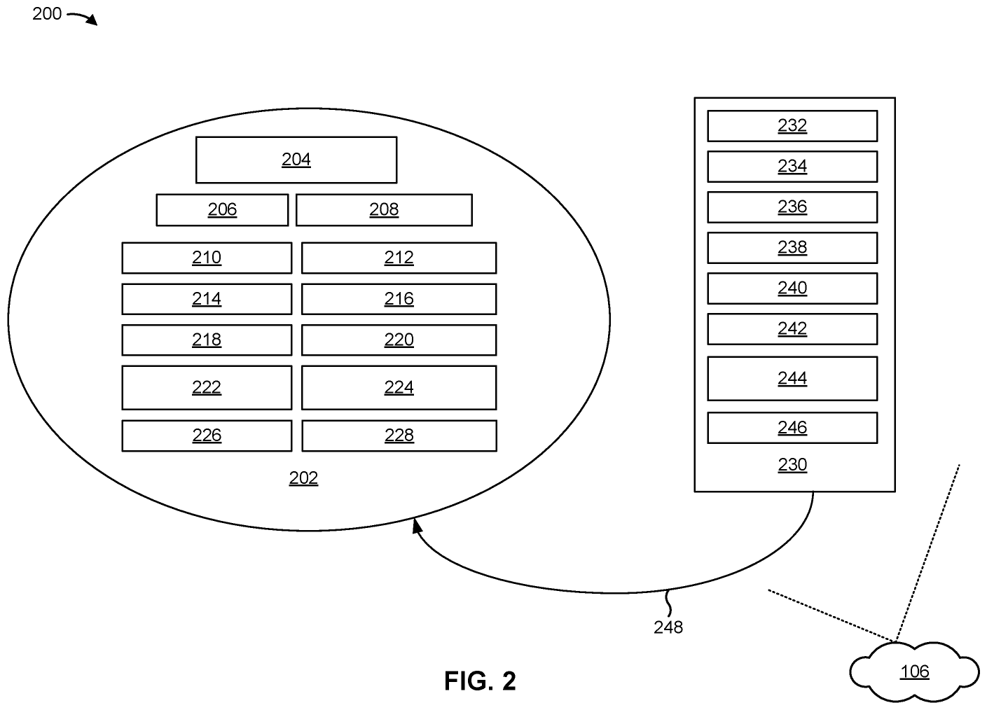

FIG. 2 is a diagram of an example implementation 200 described herein. The example implementation 200 may include an example of a machine learning model 202 that may be used by the core cloud environment 106 to perform the data deduplication techniques described herein.

As shown in FIG. 2, the machine learning model 202 may include a model function component 204, a training corpus component 206, a feature-set function component 208, a model connector component 210, a variation manager component 212, a range collector component 214, a rules derivation component 216, a rule to boundary map component 218, a rule validity management component 220, a core repository collector component 222, an attribute to range definition component 224, an access controller 226, and/or an attribute alteration component 228, among other examples. As further shown in FIG. 2, the core cloud infrastructure may include a core cloud interface 230 that includes a rule collector component 232, an attribute gathering component 234, an alteration validity component 236, edge data migrator component 238, a migration selector component 240, a rule collector component 242, a rule-based data exchange component 244, and/or edge data push component 246, among other examples. The components of the core cloud interface 230 may communicate with the machine learning model 202 through one or more data push operations 248.

In some implementations, when a ground truth is extracted, the core cloud environment 106 may create rules using the rule derivation component 216, for which the results are same. The rules may include the machine learning model 202's input attribute values, ranges, and/or internally generated values for a multi-pass model, among other examples. In some implementations, the outcome of this process results in the rules with a set of attribute values based on the relationship along with the range of each attribute for the relationship which are producing the same results (e.g., attribute to range definition component 224). This enables the core cloud environment 106 to determine that attribute metadata and relationships are the range bound attributes, and that the attribute metadata and the attribute relation are not needed in their accurate presentation. In some implementations, if the exact values are identified to not be needed, when the ground truth is obtained frequently from the core cloud environment 106, the repository datasets may be migrated from core cloud interface 230 by the edge data migrator component 238, the migration selector component 240, and/or the edge data push component 246 to the edge cloud environment 104. In some implementations, the model rules are created for the range attribute with relations, and the message is sent to the peer process running at cloud services for which data migration in the data materialization platform is performed, where the core cloud environment 106 receives the message and determines the range orientation of the model outcomes.

In some implementations, when a dataset migration to the edge cloud environment 104 is triggered, (e.g., by edge data migrator component 238, the migration selector component 240, and/or the edge data push component 246), the parameters of the requirements is obtained in a series orientation. Based on this understating, the data is labeled and/or identified to migrate to the edge cloud environment 104. In some implementations, the core cloud environment 106 may invoke the attribute alteration component 228 to alter the information for optimal deduplication. In some implementations, before the transmission of training datasets to the edge cloud environment 104, the training datasets are copied to a temporary space (e.g., the data repository 130), where the core cloud environment 106, using the attribute alteration component 228 initiates the datasets value alteration.

In some implementations, when an information request is received by the core cloud environment 106, from the data pull engine 114 of the edge cloud environment 104, the core cloud interface 230 may be activated to collect the requested information from one or more machine learning models (e.g., the machine learning model 202) to retrieve the information associated with pre-derived boundary values, via the core repository collector component 222 and the attribute gathering component 234. The request is shared with the machine learning model 202, and the requested attributes are received from the edge cloud environment 104. Once the attributes are extracted, the core cloud environment 106 then checks for the validity of the operations, using alteration validity component 236, and sends the information (e.g., the validated operations) to the machine learning model 202 associated with the respective attributes using the edge data migrator component 238.

In some implementations, the machine learning model 202 receives the request and locates the attributes that are to be transferred to a machine learning model repository space. The core cloud environment 106, using the machine learning model 202, identifies the attribute to range definition component 224, using the attribute gathering component 234, which determines the range of the attribute values for which the outcome does not change and records the attributes in the rules. These rules may be created for every element in the ground truth for which the information can be altered.

Rule derivations are then supplied by the rule derivation component 216 to the attribute alteration component 228, which then chooses one value replacing all the values for the attribute in the feature-sets and supplies the altered attributes to the migration selector component 240. Based on the rule collector component 232, the rule-based data exchange component 244, and/or the alteration validity component 236, the migration selector component 240 sends the feature-sets to edge cloud environment 104, using a data push operation 248.

As described above, FIG. 2 is provided as an example. Other examples may differ from what is shown and described in connection with FIG. 2.

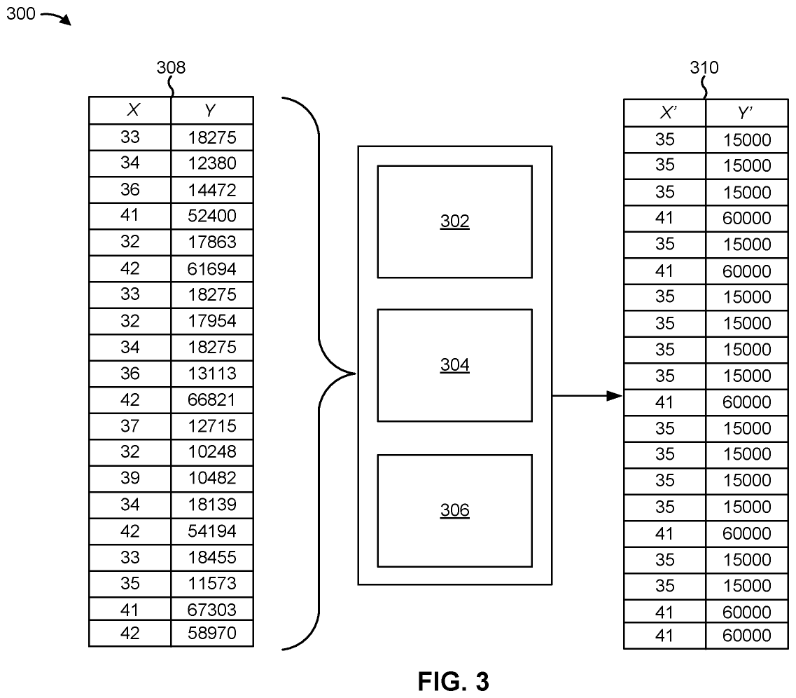

FIG. 3 is a diagram of an example implementation 300 described herein. The example implementation 300 may include an example of deduplicating records in a dataset. The operations described in connection with the example implementation 300 may be performed by a data materialization platform (e.g., the data materialization platform 401 of FIG. 4), an edge cloud environment 104, a core cloud environment 106, and edge cloud infrastructure 118, a core cloud infrastructure 132, and/or another device or system described herein.

The example implementation 300 includes an example of range-based alteration. In some implementations, rules 302-306 are obtained from a peer model process, where data in feature-set vectors from the feature-set function component 208 are altered based on their current value tuples. In some implementations, during selection of base values, the median range values are selected so that they overlap during alteration. In some implementations, the feature-set values (or records) are represented by a set of attribute values 308 that are to be altered to deduplicated attribute values 310. The deduplicated attribute values 310, along with any remaining attribute values 308 may be provided to the edge cloud environment 104.

Each attribute value may include a dataset value (X) and a vector (Y). The vectors (Y) may be values that are associated with (and/or may depend on) the value of the dataset values (X). Additionally and/or alternatively, the attribute values 308 may include only dataset values.

The dataset values (X) and vectors (Y) are updated based on the input rules (e.g., the rules 302-306) to the updated dataset values (X′) and vectors (Y′) represented in the duplicated attribute values 310. The updated dataset values (X′) and vectors (Y′) are now consistent in values resulting from the rules 302-306 being applied to the dataset values (X) and vectors (Y), where the rules 302-306 specify the median range values that are to be assigned to the dataset values (X) and vectors (Y) based on the ranges in which the dataset values (X) and vectors (Y) are included. This optimizes deduplication at the edge cloud environment 104 which conserves storage resources at the edge cloud environment 104. In some implementations, if a change in any of the rules 302-306 is detected, modified rules are supplied and data in the edge cloud environment 104 is updated to maintain consistency.

As an example of the above, attribute values 308 are verified against the alteration rules (e.g., the rules 302-306) and the boundaries defined in the alteration rules from the requested data. In some implementations, depending on the boundaries, the attribute values 308 are altered so that the attribute values consume fewer storage resources when migrated to the edge cloud environment 104. In a particular example, the attributes values 308 may be altered to 35 and 41, which correspond to 15000 and 60000 respectively, ensuring that the deduplicated attribute values 310 do not impact the outcome of machine learning.

As described above, FIG. 3 is provided as an example. Other examples may differ from what is shown and described in connection with FIG. 3.

FIG. 4 is a diagram of an example environment 400 in which systems and/or methods described herein may be implemented. As shown in FIG. 4, environment 400 may include a data materialization platform 401, which may include one or more elements of and/or may execute within a cloud computing system 402. The cloud computing system 402 may include one or more elements 403-412, as described in more detail below. As further shown in FIG. 4, environment 400 may include a network 420 and one or more client devices 102. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein, such as in connection with FIG. 5.

In some implementations, the computing hardware 403 (e.g., including the one or more processors 407, the one or more memories 408, and/or the one or more networking components 409) may implement and/or execute the edge applications component 108, the execution logic component 110, the process and data coordinator component 112, the data pull engine 114, the data repository 116, the interface 120, the networking component 140, the storage component 142, the model management component 146, the model space 148, the core cloud connector component 150, the API functions component 152, and/or the machine learning model 202 of the edge cloud environment 104. In some implementations, the computing hardware 403 (e.g., including the one or more processors 407, the one or more memories 408, and/or the one or more networking components 409) may implement and/or execute the application layer 122, the application interface 124, the data coordinator component 126, the data management layer 128, the data repository 130, and/or the core cloud interface 230 of the core cloud environment 106.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405. In some implementations, the resource management component 404 implements, or is implemented by, the hypervisor component 138 of the edge cloud infrastructure 118.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the data materialization platform 401 may include one or more elements 403-412 of the cloud computing system 402, may execute within the cloud computing system 402, and/or may be hosted within the cloud computing system 402, in some implementations, the data materialization platform 401 may not be cloud-based (e.g., may be implemented outside of a cloud computing system) or may be partially cloud-based. For example, the data materialization platform 401 may include one or more devices that are not part of the cloud computing system 402, such as device 500 of FIG. 5, which may include a standalone server or another type of computing device. The data materialization platform 401 may perform one or more operations and/or processes described in more detail elsewhere herein.

In some implementations, the data materialization platform 401 includes the edge cloud environment 104. In these implementations, the cloud computing system 402 may implement, or may be implemented by, the edge cloud infrastructure 118. Accordingly, the data materialization platform 401 and/or the cloud computing system 402 may perform one or more operations of the edge cloud environment 104 and/or the edge cloud infrastructure 118 described herein.

In some implementations, the data materialization platform 401 includes the core cloud environment 106. In these implementations, the cloud computing system 402 may implement, or may be implemented by, the core cloud infrastructure 132. Accordingly, the data materialization platform 401 and/or the cloud computing system 402 may perform one or more operations of the core cloud environment 106 and/or the core cloud infrastructure 132 described herein.

In some implementations, the data materialization platform 401 includes a combination of the edge cloud environment 104 and the core cloud environment 106, or a combination of portions of the edge cloud environment 104 and portions of the core cloud environment 106. In these implementations the cloud computing system 402 may implement, or may be implemented by, the edge cloud infrastructure 118 (or portions thereof) and the core cloud infrastructure 132 (or portions thereof). Alternatively, the data materialization platform 401 may include a first cloud computing system 402 that implements, or is implemented by, the edge cloud infrastructure 118 (or portions thereof); and a second cloud computing system 402 that implements, or is implemented by, the core cloud infrastructure 132 (or portions thereof). Accordingly, the data materialization platform 401 and/or one or more cloud computing systems 402 may perform one or more operations of the edge cloud environment 104 and/or the edge cloud infrastructure 118 described herein, and one or more operations of the core cloud environment 106 and/or the core cloud infrastructure 132 described herein.

The network 420 may include one or more wired and/or wireless networks. For example, the network 420 may include a cellular network (e.g., a 5G telecommunications network), a public land mobile network (PLMN), a local area network (LAN), a wide area network (WAN), a storage area network (SAN), a private network, the Internet, and/or a combination of these or other types of networks. The network 420 enables communication among the devices of the environment 400.

A client device 102 may include one or more devices capable of receiving, generating, storing, processing, and/or providing information associated with data materialization for repository optimization in a cloud computing environment, as described elsewhere herein. The client device 102 may include a communication device and/or a computing device. For example, the client device 102 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. In some implementations, a client device 102 includes an IoT device. IoT devices may include hardware, such as sensors, actuators, gadgets, appliances, or machines, that are programmed for certain applications and can transmit data over the Internet or other networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with data materialization for repository optimization in a cloud computing environment. In some implementations, the device 500 may correspond to and/or may execute the edge applications component 108, the execution logic component 110, the process and data coordinator component 112, the data pull engine 114, the edge cloud infrastructure 118, the data repository 116, the interface 120, the hypervisor component 138, the networking component 140, the storage component 142, the model management component 146, the model space 148, the core cloud connector component 150, the API functions component 152, the machine learning model 202 of the edge cloud environment 104. In some implementations, the edge applications component 108, the execution logic component 110, the process and data coordinator component 112, the data pull engine 114, the edge cloud infrastructure 118, the data repository 116, the interface 120, the hypervisor component 138, the networking component 140, the storage component 142, the model management component 146, the model space 148, the core cloud connector component 150, the API functions component 152, the machine learning model 202 of the edge cloud environment 104 may include one or more devices 500 and/or one or more components of the device 500.

In some implementations, the device 500 may correspond to and/or may execute the application layer 122, the application interface 124, the data coordinator component 126, the data management layer 128, the data repository 130, the core cloud infrastructure 132, and/or the core cloud interface 230 of the core cloud environment 106. In some implementations, the application layer 122, the application interface 124, the data coordinator component 126, the data management layer 128, the data repository 130, the core cloud infrastructure 132, and/or the core cloud interface 230 of the core cloud environment 106 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus.

The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein. In some implementations, the processor 520 includes the one or more processors 407. In some implementations, the one or more processors 407 include one or more processors 520.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530. In some implementations, the memory 530 includes the data repository 116, the data repository 130, storage component 142, and/or the one or more memories 408, among other examples. In some implementations, the data repository 116, the data repository 130, storage component 142, and/or the one or more memories 408 include one or more memories 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, an accelerometer, a gyroscope, and/or an actuator. The output component 550 may enable the device 500 to provide output, such as via a display, a speaker, and/or a light-emitting diode.

The communication component 560 may enable the device 500 to communicate with other devices via a wired connection and/or a wireless connection. For example, the communication component 560 may include a receiver, a transmitter, a transceiver, a modem, a network interface card, and/or an antenna. In some implementations, the communication component 560 includes the networking component 140 and/or the one or more networking components 409. In some implementations, the networking component 140 and/or the one or more networking components 409 include one or more communication components 560.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

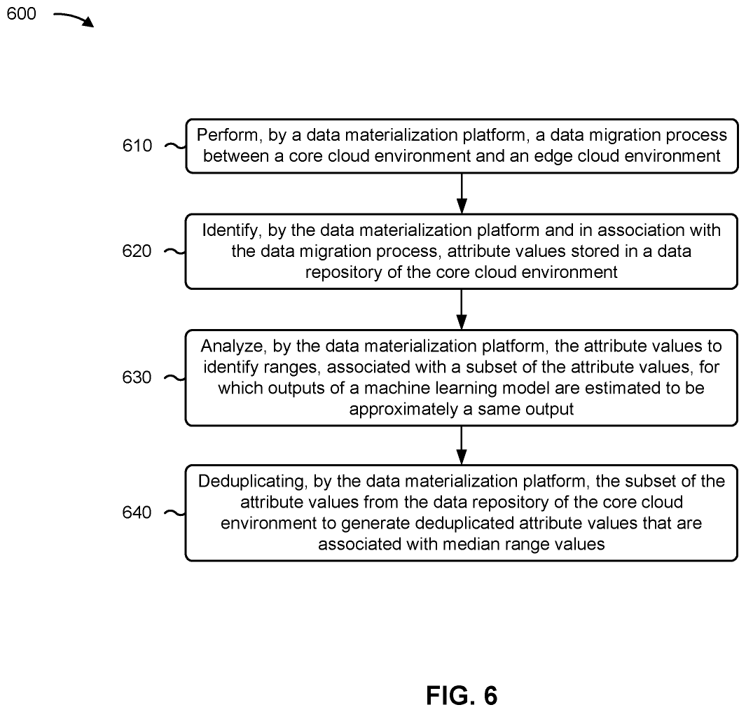

FIG. 6 is a flowchart of an example process 600 associated with data materialization for repository optimization in a cloud computing environment. In some implementations, one or more process blocks of FIG. 6 are performed by a data materialization platform (e.g., the data materialization platform 401, the device 500). In some implementations, one or more process blocks of FIG. 6 are performed by another device or a group of devices separate from or including the data materialization platform, such as the edge cloud environment 104, the core cloud environment 106, the edge cloud infrastructure 118, and/or the core cloud infrastructure 132, among other examples. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include performing a data migration process between a core cloud environment and an edge cloud environment (block 610). For example, the data materialization platform 401 may perform a data migration process between a core cloud environment 106 and an edge cloud environment 104, as described herein.

As further shown in FIG. 6, process 600 may include identifying, in association with the data migration process, attribute values stored in a data repository of the core cloud environment (block 620). For example, the data materialization platform 401 may identify, in association with the data migration process, attribute values 308 stored in a data repository 130 of the core cloud environment 106, as described herein. In some implementations, the attribute values 308 are to be used as inputs for a machine learning model (e.g., a machine learning model 154-164, and/or 202) that is to be executed by the edge cloud environment 104. In some implementations, core cloud infrastructure 132 of the core cloud environment 106 of the data materialization platform 401 identifies, via a machine learning model and a core cloud interface 230, one or more attribute values 308 in the core cloud infrastructure 132. In some implementations, the core cloud infrastructure 132 of the core cloud environment 106 of the data materialization platform 401 identifies attribute values 308 that are stored in a data repository 130 on the core cloud infrastructure and/or utilized as inputs for a machine learning model running on the edge cloud infrastructure 118.

As further shown in FIG. 6, process 600 may include analyzing the attribute values to identify ranges, associated with a subset of the attribute values, for which outputs of the machine learning model are estimated to be approximately a same output (block 630). For example, the data materialization platform 401 may analyze the attribute values 308 to identify ranges, associated with a subset of the attribute values (e.g., attribute values 310), for which outputs of the machine learning model are estimated to be approximately a same output, as described herein. In some implementations, the core cloud infrastructure 132 of the core cloud environment 106 of the data materialization platform 401 analyzes, using a machine learning model and a core cloud interface 230, the one or more attribute values. In some implementations, the core cloud infrastructure 132 analyzes the attribute values and identifies ranges among the identified attributes for which the output of the machine learning model would be the same. In some implementations, the core cloud infrastructure 132 alters the identified attribute values to create a consistent value among attribute values within a predetermined range. In some implementations, the core cloud infrastructure 132 may identify and label attribute values that are replicated/repeated more than once.

As further shown in FIG. 6, process 600 may include deduplicating the subset of the attribute values from the data repository of the core cloud environment to generate deduplicated attribute values that are associated with median range values (block 640). For example, the data materialization platform 401 may deduplicate the subset of the attribute values from the data repository 130 of the core cloud environment 106 to generate deduplicated attribute values that are associated with median range values, as described herein. In various embodiments, the core cloud infrastructure 132 of the core cloud environment 106 of the data materialization platform 401 deduplicates one or more identified repetitive attribute values using the core cloud interface 230. In some implementations, the core cloud infrastructure 132 deduplicates the attribute values from the data repository 130 to correspond to a predetermined or calculated median range of values prior to migrating the values from the core cloud infrastructure 132 to the edge cloud infrastructure 118.

Process 600 may include additional implementations, such as any single implementation or any combination of implementations described below and/or in connection with one or more other processes described elsewhere herein.

In a first implementation, process 600 includes utilizing the deduplicated attribute values as inputs to the machine learning model.

In a second implementation, alone or in combination with the first implementation, process 600 includes storing the deduplicated attribute values on the edge cloud environment 104.

In a third implementation, alone or in combination with one or more of the first and second implementations, process 600 includes modifying or replacing the attribute values based on generated rules to generate modified attribute values.

In a fourth implementation, alone or in combination with one or more of the first through third implementations, process 600 includes migrating the modified attribute values to the data repository 116 of the edge cloud environment 104. The core cloud infrastructure 132 of the core cloud environment 106 of the data materialization platform 401 may migrate the duplicated attribute values to the edge cloud environment 104.

In a fifth implementation, alone or in combination with one or more of the first through fourth implementations, process 600 includes validating one or more operations associated with identifying the attribute values 308, and providing, based on validating the one or more operations, the one or more operations to the machine learning model via an edge data migrator component 238.

In a sixth implementation, alone or in combination with one or more of the first through fifth implementations, process 600 includes receiving an information request associated with the edge cloud environment 104, obtaining, based on receiving the information request, information associated with one or more pre-derived boundary values from one or more machine learning models that include the machine learning model, and providing the information associated with the one or more pre-derived boundary values to satisfy the information request.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

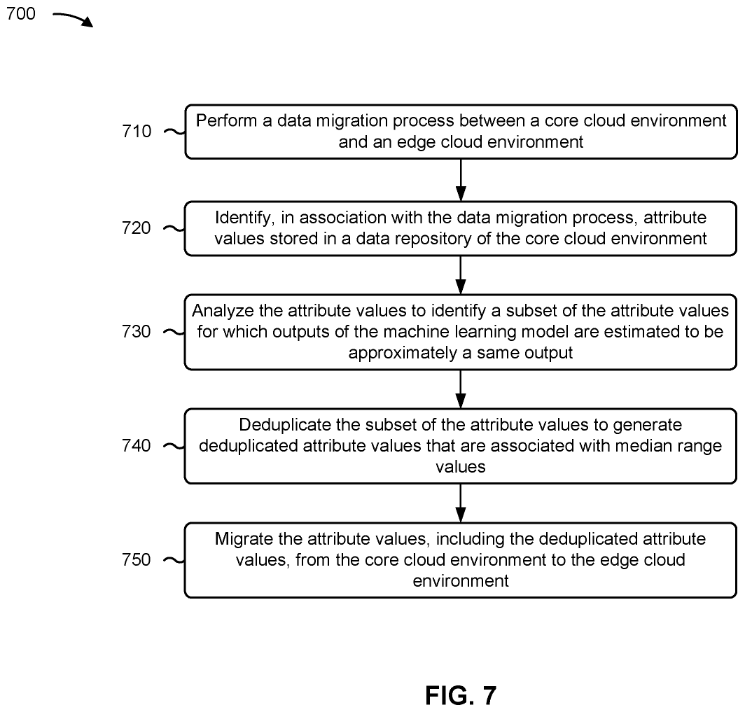

FIG. 7 is a flowchart of an example process 700 associated with data materialization for repository optimization in a cloud computing environment. In some implementations, one or more process blocks of FIG. 7 are performed by a data materialization platform (e.g., the data materialization platform 401, the device 500). In some implementations, one or more process blocks of FIG. 7 are performed by another device or a group of devices separate from or including the data materialization platform, such as the edge cloud environment 104, the core cloud environment 106, the edge cloud infrastructure 118, and/or the core cloud infrastructure 132, among other examples. Additionally, or alternatively, one or more process blocks of FIG. 7 may be performed by one or more components of device 500, such as processor 520, memory 530, input component 540, output component 550, and/or communication component 560.

As shown in FIG. 7, process 700 may include performing a data migration process between a core cloud environment and an edge cloud environment (block 710). For example, the data materialization platform 401 may perform a data migration process between a core cloud environment 106 and an edge cloud environment 104, as described herein.

As further shown in FIG. 7, process 700 may include identifying, in association with the data migration process, attribute values stored in a data repository of the core cloud environment (block 720). For example, the data materialization platform 401 may identify, in association with the data migration process, attribute values 308 stored in a data repository 130 of the core cloud environment 106, as described herein. In some implementations, the attribute values 308 are to be used as inputs for a machine learning model (e.g., a machine learning model 154-164, and/or 202) that is to be executed by the edge cloud environment 104.

As further shown in FIG. 7, process 700 may include analyzing the attribute values to identify a subset of the attribute values for which outputs of the machine learning model are estimated to be approximately a same output (block 730). For example, the data materialization platform 401 may analyze the attribute values 308 to identify a subset of the attribute values (e.g., attribute values 310) for which outputs of the machine learning model are estimated to be approximately a same output, as described herein.

As further shown in FIG. 7, process 700 may include deduplicating the subset of the attribute values to generate deduplicated attribute values that are associated with median range values (block 740). For example, the data materialization platform 401 may deduplicate the subset of the attribute values to generate deduplicated attribute values that are associated with median range values, as described herein.

As further shown in FIG. 7, process 700 may include migrating the attribute values, including the deduplicated attribute values, from the core cloud environment to the edge cloud environment (block 750). For example, the data materialization platform may migrate the attribute values 308, including the deduplicated attribute values, from the core cloud environment 106 to the edge cloud environment 104, as described herein.

Process 700 may include additional implementations, such as any single implementation or any combination of implementations described below and/or in connection with one or more other processes described elsewhere herein.

In a first implementation, process 700 includes identifying a first attribute value and a second attribute value, from among the subset of the attribute values, for which outputs of the machine learning model are estimated to be approximately the same output, determining a median range value, of the median range values, based on a first range value associated with the first attribute value and a second range value associated with the second range value, and associating the median range value with a deduplicated attribute value of the deduplicated attribute values.

In a second implementation, alone or in combination with the first implementation, process 700 includes removing the first attribute value and the second attribute value from the attribute values 308, and replacing the first attribute value and the second attribute value, in the attribute values, with the deduplicated attribute value.

In a third implementation, alone or in combination with one or more of the first and second implementations, process 700 includes analyzing, using another machine learning model, the attribute values 308 to identify ranges associated with the attribute values.

In a fourth implementation, alone or in combination with one or more of the first through third implementations, process 700 includes labeling the subset of the attribute values as repetitive attribute values.

In a fifth implementation, alone or in combination with one or more of the first through fourth implementations, process 700 includes determining that the subset of the attribute values are within an attribute value range for which outputs of the machine learning model are estimated to be approximately the same output.

In a sixth implementation, alone or in combination with one or more of the first through fifth implementations, process 700 includes identifying a median value range, of the median value ranges, based on the median value range being associated with the attribute value range.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

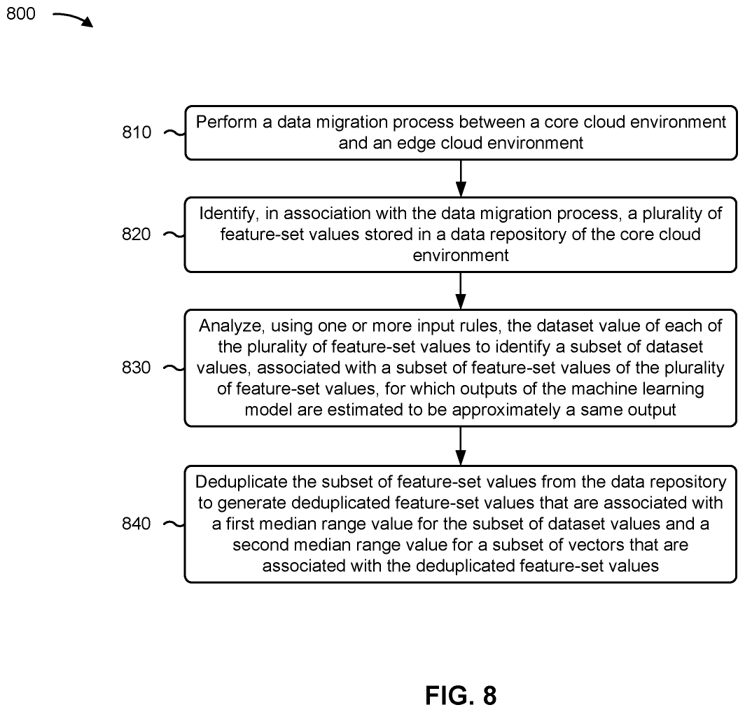

FIG. 8 is a flowchart of an example process 800 associated with data materialization for repository optimization in a cloud computing environment. In some implementations, one or more process blocks of FIG. 8 are performed by a data materialization platform (e.g., the data materialization platform 401, the device 500). In some implementations, one or more process blocks of FIG. 8 are performed by another device or a group of devices separate from or including the data materialization platform, such as the edge cloud environment 104, the core cloud environment 106, the edge cloud infrastructure 118, and/or the core cloud infrastructure 132, among other examples. Additionally, or alternatively, one or more process blocks of FIG. 8 may be performed by one or more components of device 500, such as processor 520, memory 530, input component 540, output component 550, and/or communication component 560.

As shown in FIG. 8, process 800 may include performing a data migration process between a core cloud environment and an edge cloud environment (block 810). For example, the data materialization platform 401 may perform a data migration process between a core cloud environment 106 and an edge cloud environment 104, as described herein.

As further shown in FIG. 8, process 800 may include identifying, in association with the data migration process, a plurality of feature-set values stored in a data repository of the core cloud environment (block 820). For example, the data materialization platform may identify, in association with the data migration process, a plurality of feature-set values stored in a data repository 130 of the core cloud environment 106, as described herein. In some implementations, the plurality of feature-set values each includes a dataset value (X) and a vector (Y). In some implementations, the dataset value and the vector of each of the plurality of feature-set values are to be used as inputs for a machine learning model (e.g., a machine learning model 154-164, and/or 202) that is to be executed by the edge cloud environment 104.

As further shown in FIG. 8, process 800 may include analyzing, using one or more input rules, the dataset value of each of the plurality of feature-set values to identify a subset of dataset values, associated with a subset of feature-set values of the plurality of feature-set values, for which outputs of the machine learning model are estimated to be approximately a same output (block 830). For example, the data materialization platform 401 may analyze, using one or more input rules 302-304, the dataset value of each of the plurality of feature-set values to identify a subset of dataset values, associated with a subset of feature-set values of the plurality of feature-set values, for which outputs of the machine learning model are estimated to be approximately a same output, as described herein.

As further shown in FIG. 8, process 800 may include deduplicating the subset of feature-set values from the data repository to generate deduplicated feature-set values that are associated with a first median range value for the subset of dataset values and a second median range value for a subset of vectors that are associated with the deduplicated feature-set values (block 840). For example, the data materialization platform 401 may deduplicate the subset of feature-set values from the data repository to generate deduplicated feature-set values (e.g., including attribute values 310) that are associated with a first median range value for the subset of dataset values and a second median range value for a subset of vectors that are associated with the deduplicated feature-set values, as described herein.

Process 800 may include additional implementations, such as any single implementation or any combination of implementations described below and/or in connection with one or more other processes described elsewhere herein.

In a first implementation, process 800 includes determining that the subset of dataset values are within a dataset value range, where the dataset value range includes a range of dataset values for which outputs of the machine learning model 202 are estimated to be approximately the same output.

In a second implementation, alone or in combination with the first implementation, the first median range value is associated with the dataset value range.

In a third implementation, alone or in combination with one or more of the first and second implementations, process 800 includes identifying the first median range value based on a first input rule of the one or more input rules 302-306, and identifying the second median range value based on a second input rule of the one or more input rules 302-306.

In a fourth implementation, alone or in combination with one or more of the first through third implementations, the second input rule associates the second median range value with the first median range value.

In a fifth implementation, alone or in combination with one or more of the first through fourth implementations, process 800 includes migrating the plurality of feature-set values, including the deduplicated feature-set values, from the core cloud environment 106 to the edge cloud environment 104.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

In this way, a data materialization platform may transfer or migrate data between a core cloud environment and an edge cloud environment to support advanced processing operations such as machine learning. In connection with migration of a data set that includes many records (e.g., thousands of records, millions of records), the core cloud environment may deduplicate the data set to reduce the amount of storage resources that are consumed by the core cloud environment in storing the data set. In particular, records that have attribute values that are within a same range may be deduplicated such that storage resources and/or memory resources of the edge cloud environment can be conserved. Moreover, records that have attribute values that are within a same range may be deduplicated such that the storage resources and/or the memory resources of the edge cloud environment can be used to store other records that have attribute values that do provide increased data differentiation for training the machine learning model. This enables the edge cloud environment to more effectively train the machine learning model to provide more accurate outputs. This reduces the likelihood that the edge cloud environment will rerun the machine learning model in order to generate an accurate output, which may conserve processing resources and memory resources of the edge cloud environment.

As described in greater detail above, some implementations described herein provide a method. The method includes performing, by a data materialization platform, a data migration process between a core cloud environment and an edge cloud environment. The method includes identifying, by the data materialization platform and in association with the data migration process, attribute values stored in a data repository of the core cloud environment, where the attribute values are to be used as inputs for a machine learning model that is to be executed by the edge cloud environment. The method includes analyzing, by the data materialization platform, the attribute values to identify ranges, associated with a subset of the attribute values, for which outputs of the machine learning model are estimated to be approximately a same output. The method includes deduplicating, by the data materialization platform, the subset of the attribute values from the data repository of the core cloud environment to generate deduplicated attribute values that are associated with median range values.

As described in greater detail above, some implementations described herein provide a data materialization platform. The data materialization platform includes one or more memories. The data materialization platform includes one or more processors, communicatively coupled to the one or more memories. The one or more processors are configured to perform a data migration process between a core cloud environment and an edge cloud environment. The one or more processors are configured to identify, in association with the data migration process, attribute values stored in a data repository of the core cloud environment, where the attribute values are to be used as inputs for a machine learning model that is to be executed by the edge cloud environment. The one or more processors are configured to analyze the attribute values to identify a subset of the attribute values for which outputs of the machine learning model are estimated to be approximately a same output. The one or more processors are configured to deduplicate the subset of the attribute values to generate deduplicated attribute values that are associated with median range values. The one or more processors are configured to migrate the attribute values, including the deduplicated attribute values, from the core cloud environment to the edge cloud environment.

As described in greater detail above, some implementations described herein provide a non-transitory computer-readable medium that stores a set of instructions. The set of instructions includes one or more instructions that, when executed by one or more processors of a data materialization platform, cause the data materialization platform to perform a data migration process between a core cloud environment and an edge cloud environment. The set of instructions includes one or more instructions that, when executed by one or more processors of the data materialization platform, cause the data materialization platform to identify, in association with the data migration process, a plurality of feature-set values stored in a data repository of the core cloud environment, where the plurality of feature-set values each includes a dataset value and a vector, and where the dataset value and the vector of each of the plurality of feature-set values are to be used as inputs for a machine learning model that is to be executed by the edge cloud environment. The set of instructions includes one or more instructions that, when executed by one or more processors of the data materialization platform, cause the data materialization platform to analyze, using one or more input rules, the dataset value of each of the plurality of feature-set values to identify a subset of dataset values, associated with a subset of feature-set values of the plurality of feature-set values, for which outputs of the machine learning model are estimated to be approximately a same output. The set of instructions includes one or more instructions that, when executed by one or more processors of the data materialization platform, cause the data materialization platform to deduplicate the subset of feature-set values from the data repository to generate deduplicated feature-set values that are associated with a first median range value for the subset of dataset values and a second median range value for a subset of vectors that are associated with the deduplicated feature-set values.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
performing, by a data materialization platform, a data migration process between a core cloud environment and an edge cloud environment;
identifying, by the data materialization platform and in association with the data migration process, attribute values stored in a data repository of the core cloud environment,
wherein the attribute values are to be used as inputs for a machine learning model that is to be executed by the edge cloud environment;
analyzing, by the data materialization platform, the attribute values to identify ranges, associated with a subset of the attribute values, for which outputs of the machine learning model are estimated to be approximately a same output; and
deduplicating, by the data materialization platform, the subset of the attribute values from the data repository of the core cloud environment to generate deduplicated attribute values that are associated with median range values.

2. The method of claim 1, further comprising:
utilizing the deduplicated attribute values as inputs to the machine learning model.

3. The method of claim 1, further comprising:
storing the deduplicated attribute values on the edge cloud environment.

4. The method of claim 1, further comprising:
modifying the attribute values based on generated rules to generate modified attribute values.

5. The method of claim 4, further comprising:
migrating the modified attribute values to the data repository of the edge cloud environment.

6. The method of claim 1, further comprising:
validating one or more operations associated with identifying the attribute values; and
providing, based on validating the one or more operations, the one or more operations to the machine learning model via an edge data migrator.

7. The method of claim 1, further comprising:
receiving an information request associated with the edge cloud environment;
obtaining, based on receiving the information request, information associated with one or more pre-derived boundary values from one or more machine learning models that include the machine learning model; and
providing the information associated with the one or more pre-derived boundary values to satisfy the information request.

8. A data materialization platform, comprising:
one or more memories; and
one or more processors, communicatively coupled to the one or more memories, configured to:
perform a data migration process between a core cloud environment and an edge cloud environment;
identify, in association with the data migration process, attribute values stored in a data repository of the core cloud environment,
wherein the attribute values are to be used as inputs for a machine learning model that is to be executed by the edge cloud environment;
analyze the attribute values to identify a subset of the attribute values for which outputs of the machine learning model are estimated to be approximately a same output;
deduplicate the subset of the attribute values to generate deduplicated attribute values that are associated with median range values; and
migrate the attribute values, including the deduplicated attribute values, from the core cloud environment to the edge cloud environment.

9. The data materialization platform of claim 8, wherein the one or more processors, to deduplicate the subset of the attribute values, are configured to:
identify a first attribute value and a second attribute value, from among the subset of the attribute values, for which outputs of the machine learning model are estimated to be approximately the same output;
determine a median range value, of the median range values, based on a first range value associated with the first attribute value and a second range value associated with the second range value; and
associate the median range value with a deduplicated attribute value of the deduplicated attribute values.

10. The data materialization platform of claim 9, wherein the one or more processors, to deduplicate the subset of the attribute values, are configured to:
remove the first attribute value and the second attribute value from the attribute values; and
replace the first attribute value and the second attribute value, in the attribute values, with the deduplicated attribute value.

11. The data materialization platform of claim 8, wherein the one or more processors, to analyze the attribute values, are configured to:
analyze, using another machine learning model, the attribute values to identify ranges associated with the attribute values.

12. The data materialization platform of claim 8, wherein the one or more processors are further configured to:
label the subset of the attribute values as repetitive attribute values.

13. The data materialization platform of claim 8, wherein the one or more processors, to analyze the attribute values to identify the subset of the attribute values, are configured to:
determine that the subset of the attribute values are within an attribute value range for which outputs of the machine learning model are estimated to be approximately the same output.

14. The data materialization platform of claim 13, wherein the one or more processors are configured to:
identify a median value range, of the median value ranges, based on the median value range being associated with the attribute value range.

15. A non-transitory computer-readable medium storing a set of instructions, the set of instructions comprising:
one or more instructions that, when executed by one or more processors of a data materialization platform, cause the data materialization platform to:
perform a data migration process between a core cloud environment and an edge cloud environment;
identify, in association with the data migration process, a plurality of feature-set values stored in a data repository of the core cloud environment,
wherein the plurality of feature-set values each includes a dataset value and a vector, and
wherein the dataset value and the vector of each of the plurality of feature-set values are to be used as inputs for a machine learning model that is to be executed by the edge cloud environment;
analyze, using one or more input rules, the dataset value of each of the plurality of feature-set values to identify a subset of dataset values, associated with a subset of feature-set values of the plurality of feature-set values, for which outputs of the machine learning model are estimated to be approximately a same output; and
deduplicate the subset of feature-set values from the data repository to generate deduplicated feature-set values that are associated with a first median range value for the subset of dataset values and a second median range value for a subset of vectors that are associated with the deduplicated feature-set values.

16. The non-transitory computer-readable medium of claim 15, wherein the one or more instructions, that cause the one or more processors to analyze the dataset value of each of the plurality of feature-set values, cause the data materialization platform to:
determine that the subset of dataset values are within a dataset value range,
wherein the dataset value range includes a range of dataset values for which outputs of the machine learning model are estimated to be approximately the same output.

17. The non-transitory computer-readable medium of claim 16, wherein the first median range value is associated with the dataset value range.

18. The non-transitory computer-readable medium of claim 15, wherein the one or more instructions, when executed by the one or more processors, further cause the data materialization platform to:
identify the first median range value based on a first input rule of the one or more input rules; and
identify the second median range value based on a second input rule of the one or more input rules.

19. The non-transitory computer-readable medium of claim 18, wherein the second input rule associates the second median range value with the first median range value.

20. The non-transitory computer-readable medium of claim 15, wherein the one or more instructions, when executed by the one or more processors, further cause the data materialization platform to:
migrate the plurality of feature-set values, including the deduplicated feature-set values, from the core cloud environment to the edge cloud environment.
